(19) United States
(12) Patent Application Publication
(10) Pub. No.: US 2015/0329676 A1
(43) Pub. Date: Nov. 19, 2015

(54) THERMOPLASTIC POLYIMIDE, THERMOPLASTIC POLYIMIDE FOAM BODY, AND METHOD FOR PRODUCING THE SAME

(71) Applicants: Hirokazu MIYAKE, Shizuoka (JP); Chiaki TANAKA, Shizuoka (JP); Susumu CHIBA, Shizuoka (JP); Yukihiro IMANAGA, Shizuoka (JP)

(72) Inventors: Hirokazu MIYAKE, Shizuoka (JP); Chiaki TANAKA, Shizuoka (JP); Susumu CHIBA, Shizuoka (JP); Yukihiro IMANAGA, Shizuoka (JP)

(21) Appl. No.: 14/703,080

(22) Filed: May 4, 2015

(30) Foreign Application Priority Data
May 16, 2014 (JP) 2014-101980

(51) Int. Cl. C08G 73/10

(52) U.S. Cl. CPC C08G 73/1085

(57) ABSTRACT

A thermoplastic polyimide, including a repeating unit represented by the following General Formula I, wherein an amount of an organic solvent in the thermoplastic polyimide detected by gas chromatography is 5 ppm by mass or less,

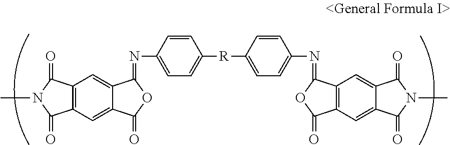

where in the General Formula I, R represents a divalent organic group.

### BACKGROUND OF THE INVENTION

1. Field of the Invention

The present invention relates to a thermoplastic polyimide, a thermoplastic polyimide foam body, and methods for producing the same.

2. Description of the Related Art

In recent years, a circuit line and width interval of the circuit line of an electronic circuit substrate have been micronized because the speed of the arithmetic processing is getting faster. Thus, demand has arisen for insulating materials which cover the circuit line and are excellent in high insulation property, high heat resistance, low thermal expandability, and low permittivity. In order to solve these demands, a polyimide resin, which has high glass transition temperature, linear thermal expansion, electric insulation property, high elastic modulus, flex resistance, high heat resistance, and solvent resistance, is focused as the insulating materials which cover the circuit line.

The polyimide resin is generally obtained by reacting tetracarboxylic dianhydride with a diisocyanate compound. The obtained polyimide resin has solvent resistance, and thus powders of a low-molecular polyimide are precipitated in the solution. Thus, there is a problem with difficulty in obtaining a molded product of polyimide having high strength.

Therefore, one method is proposed for heating a polyimide resin at a long time and high temperature in order to remove the solvent therein, where the polyimide is obtained by heating polyamic acid at 250° C. or more, followed by imidation, to thereby convert it into polyimide, where the polyamic acid, which is a polyimide precursor, is synthesized by reacting tetracarboxylic dianhydride with a diamine compound in a solution (see, for example, Japanese Patent Application Laid-Open (JP-A) No. 2010-215840). However, the polyimide resin obtained by this proposed method exhibits thermosetting property, when it is heated at a high temperature during imidation, and thus there is a problem with difficulty in metallic molding using an extruder or a hot press.

Moreover, a method is proposed for obtaining a thermoplastic polyimide by reacting tetracarboxylic dianhydride with a diamine compound using an imidation accelerator, to thereby cause imidation reaction at a low temperature (see, for example, Japanese Patent Application Laid-Open (JP-A) No. 2004-359868). However, in this proposed method, a polymerization solvent is used in order to cause imidation reaction, and thus the organic solvent remains in a molded product obtained by the aforementioned method, which is a problem with difficulty in obtaining a thermoplastic polyimide having sufficient insulation property. Moreover, there is a problem in that synthesis of the polyimide resin accompanies dehydration reaction, and thus a high-temperature drying step or a reduced-pressure drying step is necessary in order to volatilize water existing as a cluster in the polyimide resin out of the polyimide resin system, which leads to a complicated step for producing the polyimide resin.

Proposed is a method for obtaining a porous imide resin, where the porous imide resin is obtained as follows: poltamic acid is mixed in the solution, then the resultant mixture is heated and dried at a low temperature until a self-supported film thereof is molded, to thereby form a film of the porous imide resin, which is heated and imidated to thereby obtain the porous imide resin (see, for example, Japanese Patent Application Laid-Open (JP-A) No. 2003-026850). Also, proposed is a method for obtaining a molded product of a foamed polyimide by injecting inert gas into a molded product of polyimide under high pressure, followed by rapidly reducing the pressure (see, for example, Japanese Patent Application Laid-Open (JP-A) No. 2001-055464).

However, a step of polymerizing polyamic acid, a step of converting polyamic acid into polyimide, and a step of foaming polyimide are necessary in these proposed methods. As a result, there are problems in that a step of polymerizing polyimide is complicated, and yield of the polyimide is poor.

### SUMMARY OF THE INVENTION

An object of the present invention is to provide a thermoplastic polyimide containing substantially no organic solvent and having high quality.

As means for solving the above problems, a thermoplastic polyimide of the present invention includes a repeating unit represented by the following General Formula I, wherein an amount of an organic solvent in the thermoplastic polyimide detected by gas chromatography is 5 ppm by mass or less.

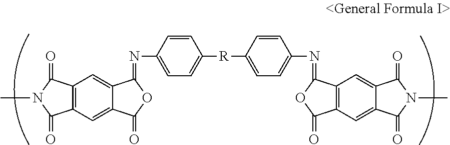

where in the General Formula I, R represents a divalent organic group.

According to the present invention, it is possible to provide a thermoplastic polyimide containing substantially no organic solvent and having high quality. This thermoplastic polyimide can solve the above problems and achieve the object.

### BRIEF DESCRIPTION OF THE DRAWINGS

FIG. 1 is a general phase diagram depicting the state of a substance depending on pressure and temperature conditions.

FIG. 2 is a phase diagram which defines a range of a compressive fluid.

FIG. 3 is a system diagram showing one exemplary batch-type polymerization reactor.

FIG. 4 is a schematic diagram showing one exemplary discharging device.

### DETAILED DESCRIPTION OF THE INVENTION

### Thermoplastic Polyimide

In a first aspect, a thermoplastic polyimide of the present invention includes a repeating unit represented by the following General Formula I, wherein an amount of an organic solvent in the thermoplastic polyimide detected by gas chromatography is 5 ppm by mass or less.

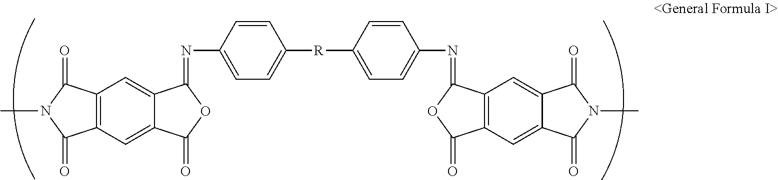

where in the General Formula I, R represents a divalent organic group.

In a second aspect, a thermoplastic polyimide of the present invention includes a repeating unit represented by the following General Formula II, wherein an amount of an organic solvent detected in the thermoplastic polyimide by gas chromatography is 5 ppm by mass or less.

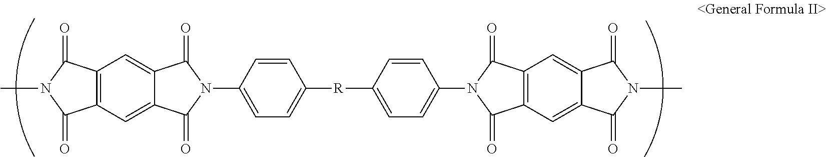

where in the General Formula II, R represents a divalent organic group.

In a third aspect, a thermoplastic polyimide of the present invention includes a repeating unit represented by the following Structural Formula I, wherein an amount of an organic solvent detected in the thermoplastic polyimide by gas chromatography is 5 ppm by mass or less.

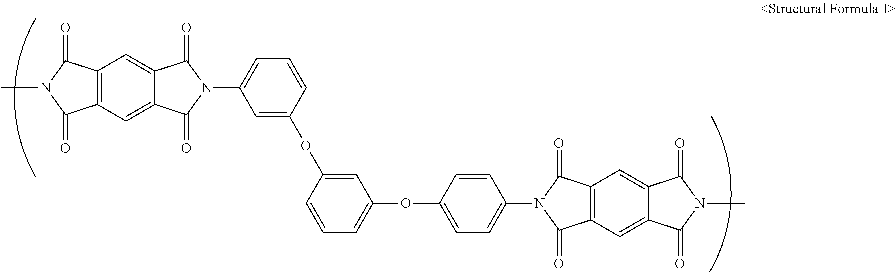

The divalent organic group in the General Formula I and the General Formula II is not particularly limited and may be appropriately selected depending on the intended purpose. Examples thereof include groups represented by the following structural formulae.

—O—

CH₂ₙ

where n represents an integer of 1 to 10.

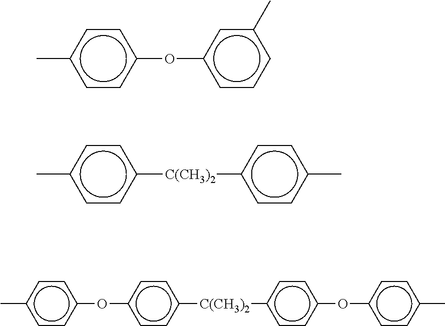

In the thermoplastic polyimides according to the first aspect to the third aspect, any of the thermoplastic polyimides is produced by the below-described method for producing a thermoplastic polyimide of the present invention, in which an organic solvent is not used. Therefore, an amount of an organic solvent in the thermoplastic polyimide detected by gas chromatography is 5 ppm by mass or less, and preferably, the thermoplastic polyimide contains substantially no organic solvent. As a result, the obtained thermoplastic polyimide is excellent in safety and stability, and has excellent insulation property and low permittivity, and thus is suitably used for, for example, electronic components.

When the amount of the organic solvent of detected in the thermoplastic polyimide by gas chromatography is more than 5 ppm by mass, insulation property and low permittivity of the obtained thermoplastic polyimide may be insufficient.

The organic solvent means a polymerization solvent used for solution polymerization of polyimide. “Containing substantially no organic solvent” means that the amount of the organic solvent in a polyimide resin measured by the following measurement method is equal to or lower than its detection limit.

Examples of the organic solvent include dimethyl sulfoxide, diethyl sulfoxide, N, N-dimethylformamide, N,N-diethylformamide, N,N-dimethylacetamide, N,N-diethylacetamide, N-methyl-2-pyrrolidone, phenol, o-cresol, m-cresol, p-cresol, xylenol, halogenated phenols, hexamethylphosphoramide, and γ-butyrolactone.

The amount of the organic solvent in the polyimide is a value detected by gas chromatography, and can be measured as follows, using a gas chromatograph apparatus (GC14A, product of SHIMADZU CORPORATION), for example.

First, a polyimide resin film as a measurement sample is purged with nitrogen career gas for 30 minutes while a temperature of an injection port is kept to 350° C. Then, the vaporized solvent component is trapped in a packed column in a state of room temperature. The trapped organic solvent is directly analyzed by gas chromatograph using a FID detector, and then an amount of the organic solvent in the polyimide resin film is analyzed based on direct calibration curve method.

A packed column made of glass and having an internal diameter of 3 mm×1.6 mm; “TENAX-TA” (product name, product of GL Sciences Inc.) as a filler; and nitrogen as a career gas can be used.

In the present invention, in order to confirm that the polyimide has thermoplasticity, the polyimide can be analyzed by, for example, melt mass flow rate (MFR), melt volume rate (MVR), and a melt dynamic viscoelasticity measuring apparatus.

### —Properties of Thermoplastic Polyimide—

A weight average molecular weight (Mw) of the thermoplastic polyimide is not particularly limited and may be appropriately selected depending on the intended purpose, but it is preferably 10,000 to 1,000,000, more preferably 10,000 to 500,000. When the weight average molecular weight is within the range of 10,000 to 1,000,000, the polyimide is not deteriorated in mechanical strength, and has appropriate melt viscosity. Thus, the polyimide is advantageous because it is not deteriorated in processability.

A ratio (Mw/Mn) of the weight average molecular weight (Mw) of the thermoplastic polyimide to a number average molecular weight (Mn) thereof is preferably 1.0 to 2.0.

The weight average molecular weight (Mw) and the ratio (Mw/Mn) of the polyimide resin can be measured by, for example, gel permeation chromatography.

Permittivity of the thermoplastic polyimide is preferably 2 or more, more preferably 2 to 5. When the permittivity thereof is within the range of 2 to 5, the thermoplastic polyimide has appropriate permittivity, and is a suitable material as an insulating material covering a circuit line of an electronic circuit substrate.

Here, electrostatic capacity (F) is measured at 1 kHz using “LCR meter 4284A” (device name, product of Yokogawa-Hewlett-Packard Company), to thereby determine the permittivity based on the following formula.

Permittivity (ε)=[electrostatic capacity (F)×film thickness of sample (m)]/[permittivity in vacuo×area of upper electrode (m²)]

The thermoplastic polyimide can be effectively produced by a method for producing a thermoplastic polyimide of the present invention which will be described hereinafter.

### (Method for Producing Thermoplastic Polyimide)

A method of the present invention for producing a thermoplastic polyimide is a method for producing the thermoplastic polyimide of the present invention, the method including reacting tetracarboxylic dianhydride with a diisocyanate compound, a di amine compound, or both thereof, and further includes reacting the aforementioned compounds with other components if necessary, in a thermoplastic polyimide.

Among them, reacting the tetracarboxylic dianhydride with the diisocyanate compound is preferable because it is decarboxylation reaction, liquid component (water) is not included in the reaction, and thus an extremely low organic solvent-containing polyimide can be obtained.

Also, the tetracarboxylic dianhydride is reacted with the diamine compound, to thereby synthesize polyamic acid. Then, polyamic acid is imidated, to thereby obtain polyimide. The polyimide is allowed to react in a compressive fluid, and thus a thermoplastic polyimide is produced. Therefore, a step of synthesizing polyamic acid to a step of imidating polyamic acid can be performed in one step, and thus a reaction step of imidating polyamic acid can be simplified compared with the conventional steps. Water generated in the step of synthesizing the polyimide resin can be dehydrated by reducing the pressure in the compressive fluid, and thus a specific drying step is unnecessary.

The reaction temperature is preferably 180° C. or less, more preferably 150° C. to 180° C. When the reaction temperature is more than 180° C., the obtained polyimide resin exhibits thermosetting property, and thus is deteriorated in formability.

### <Tetracarboxylic Dianhydride>

The tetracarboxylic dianhydride is not particularly limited and may be appropriately selected depending on the intended purpose. Examples thereof include aromatic tetracarboxylic dianhydride, alicyclic tetracarboxylic dianhydride, and aliphatic tetracarboxylic dianhydride. These may be used alone or in combination of two or more thereof.

The aromatic tetracarboxylic dianhydride is not particularly limited and may be appropriately selected depending on the intended purpose. Examples thereof include pyromellitic dianhydride, 3,3′,4,4′-diphenylsulphone tetracarboxylic dianhydride, 4,4′-oxydiphthalic dianhydride, 3,3′,4,4′-benzophenone tetracarboxylic dianhydride, 3,3′,4,4′-biphenyl tetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 1,1-bis(2,3-dicarboxyphenyl)ethane dianhydride, 1,2-bis(2,3-dicarboxyphenyl)ethane dianhydride, 1,1-bis(3,4-dicarboxyphenyl)ethane dianhydride, 1,2-bis(3,4-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride, 4,4′-(m-phenylenedioxy)diphthalic dianhydride, 2,3,6,7-naphthalene tetracarboxylic dianhydride, 1,4,5,8-naphthalene tetracarboxylic dianhydride, 1,2-ethylenebis(anhydrotrimellitate), 1,3,3a,4,5,9b-haxahydro-5-(tetrahydro-2,5-dioxo-3-furanyl)naphtho[1,2-c]furan-1,3-dion, or derivatives thereof. These may be used alone or in combination of two or more thereof. Among them, pyromellitic dianhydride and diphenyl-3,3′,4,4′-tetracarboxylic dianhydride are preferable.

The alicyclic tetracarboxylic dianhydride is not particularly limited and may be appropriately selected depending on the intended purpose. Examples thereof include 1,2,4,5-cyclohexane tetracarboxylic dianhydride, 1,2,3,4-cyclobutane tetracarboxylic dianhydride, 1,3-dimethyl-1,2,3,4-cyclobutane tetracarboxylic acid, 1,2,3,4-cyclopentane tetracarboxylic dianhydride, 2,3,5-tricarboxy cyclopentyl acetic acid dianhydride, 3,5,6-tricarboxy norbonane-2-acetic acid dianhydride, 2,3,4,5-tetrahydrofrane tetracarboxylic dianhydride, 5-(2,5-dioxotetrahydrofral)-3-methyl-3-cyclohexene-1,2-dicarboxylic acid dianhydride, bicyclo[2.2.2]-ortho-7-en-2,3,5,6-tetracarboxylic dianhydride, or derivatives thereof. These may be used alone or in combination of two or more thereof.

The aliphatic tetracarboxylic dianhydride is not particularly limited and may be appropriately selected depending on the intended purpose. Examples thereof include 1,2,3,4-butane tetracarboxylic dianhydride, 1,2,3,4-pentane tetracarboxylic dianhydride, or derivatives thereof.

### <Diisocyanate Compound>

The diisocyanate is not particularly limited and may be appropriately selected depending on the intended purpose. Examples thereof include 1,5-naphthalene diisocyanate, 2,4-toluylene diisocyanate, 2,6-toluylene diisocyanate, naphthalene diisocyanate, m-phenylene diisocyanate, diphenyl ether-4,4′-diisocyanate, diphenyl ether-2,4′-diisocyanate, tolylene diisocyanate, 4,4′-diphenylmethane diisocyanate, 4,4′-dicyclohexylmethane diisocyanate, isophorone diisocyanate, 1,3-phenylene diisocyanate, 1,4-phenylene diisocyanate, 2,4′-naphthylene diisocyanate, 1,5-naphthylene diisocyanate, m-isocyanato phenylsulfonyl isocyanate, p-isocyanato phenylsulfonyl isocyanate, ethylene diisocyanate, tetramethylene diisocyanate, hexamethylene diisocyanate, dodecamethylene diisocyanate, 2,2,4-trimethyl hexamethylene diisocyanate, lysine diisocyanate, 4,4′-dicyclohexylmethane diisocyanate, cyclohexylene diisocyanate, methylcyclohexylene diisocyanate, bis(2-isocyanatoethyl)-4-cyclohexene-1,2-dicarboxylate, 2,5-norbornane diisocyanate, 2,6-norbornane diisocyanate, isophorone diisocyanate, m-xylylene diisocyanate, p-xylylene diisocyanate, α,α,α,α′-tetramethyl xylylene diisocyanate, and 1,3-bis(3-isocyanato propyl)-1,1,3,3-tetramethyl disiloxane. These may be used alone or in combination of two or more thereof. Among them, diphenyl ether-2,4′-diisocyanate and diphenyl ether-4,4′-diisocyanate are preferable.

The diisocyanate compound is not particularly limited and may be appropriately selected depending on the intended purpose. Examples thereof include the following chemical formulae A to C. Among them, a meta foam represented by the chemical formula B or a para form represented by the chemical formula C is preferable.

OCN—R—NCO [Chemical formula A]

In the chemical formula A, R represents a divalent organic group.

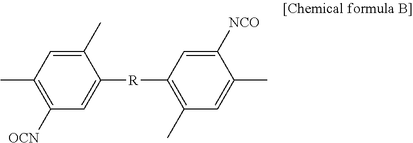

In the chemical formula B, R represents a divalent organic group.

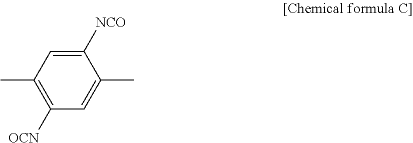

### <Diamine Compound>

The diamine compound is not particularly limited and may be appropriately selected depending on the intended purpose. Examples thereof include an aromatic diamine compound and an aliphatic diamine compound. These may be used alone or in combination of two or more thereof. Among them, a meta-form aromatic diamine compound containing two or more ether bonds is preferable because it can impart thermoplasticity to polyimide.

### —Aromatic Diamine Compound—

The aromatic diamine compound is not particularly limited and may be appropriately selected depending on the intended purpose. Examples thereof include m-phenylene diamine, p-phenylene diamine, 4,4′-diaminodiphenylmethane, 4,4′-diamino diphenyl propane, 4,4′-diamino diphenyl ether, 3,4′-diamino diphenyl ether, 3,3′-diamino diphenyl ether, 4,4′-diamino diphenyl sulphone, 3,4′-diamino diphenyl sulphone, 3,3′-diamino diphenyl sulphone, 4,4′-diamino diphenyl sulfide, 3,4′-diamino diphenyl sulfide, 3,3′-diamino diphenyl sulfide, 1,4-bis(4-aminophenoxy)benzene, 1,3-bis(4-aminophenoxy)benzene, 1,4-bis(3-aminophenoxy)benzene, 1,3-bis(3-aminophenoxy)benzene, bis[4-(3-aminophenoxyl)phenyl]sulfone, 2,2-bis[4-(4-aminophenoxyl)phenyl]propane, 2,2-bis[4-(3-aminophenoxy)phenyl]propane, 4,4′-bis(4-aminophenoxy)biphenyl, 4,4′-bis(3-aminophenoxy)biphenyl, bis[4-(4-aminophenoxyl)phenyl]ether, bis[4-(3-aminophenoxy)phenyl]ether, 9,9-bis(4-aminophenyl)fluorene, o-tolidine, and m-tolidine. These may be used alone or in combination of two or more thereof. Among them, 2,2-bis[4-(4-aminophenoxyl)phenyl]propane and 1,4-bis(4-aminophenoxy)benzene are preferable.

### —Aliphatic Diamine Compound—

The aliphatic diamine compound is not particularly limited and may be appropriately selected depending on the intended purpose. Examples thereof include ethylene diamine, hexamethylenediamine, octamethylene diamine, and decamethylene diamine.

### <Other Components>

Examples of the other components include a reaction activator, an acidic organic compound, an aromatic compound, a catalyst, and an additive.

The reaction activator is not particularly limited and may be appropriately selected depending on the intended purpose. Examples thereof include a basic organic matter and a basic inorganic matter.

Examples of the basic organic matter include pyridine, quinoline, isoquinoline, α-picoline, β-picoline, γ-picoline, 2,4-lutidine, 2,6-lutidine, trimethylamine, trimethylamine, tripropylamine, tributylamine, imidazole, N,N-dimethylaniline, N,N-diethylaniline, triethylamine, and dimethylamine.

Examples of the basic inorganic matter include potassium hydroxide, sodium hydroxide, potassium carbonate, sodium carbonate, potassium hydrogencarbonate, and sodium hydrogencarbonate.

Examples of the acidic organic compound include crotonic acid, acrylic acid, trans-3-hexenoic acid, cinnamic acid, benzoic acid, methylbenzoic acid, oxybenzoic acid, terephthalic acid, benzenesulfonic acid, paratoluensulfonic acid, and naphthalenesulfonic acid.

Examples of the aromatic compound include phthalic anhydride and maleic anhydride. Incorporation of the aromatic compound can terminate reaction of a terminal of a thermoplastic polyimide, and thus degradation of the thermoplastic polyimide can be prevented.

Examples of the additive is not particularly limited and may be appropriately selected depending on the intended purpose. Examples thereof include a surfactant and an antioxidant.

### <Compressive Fluid>

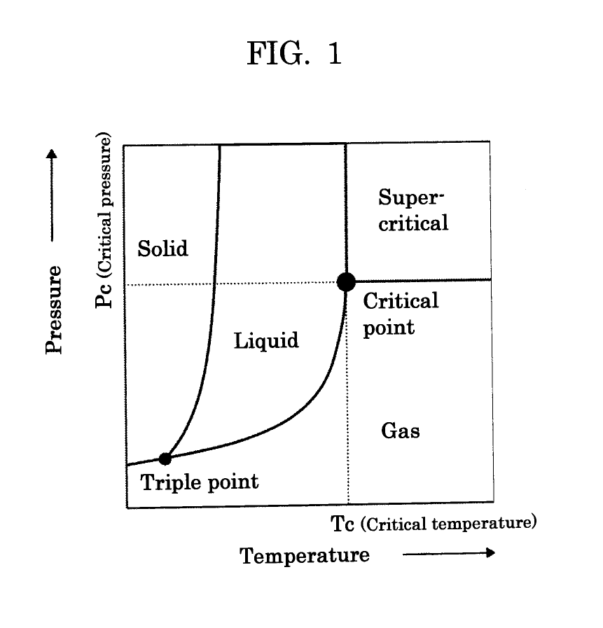

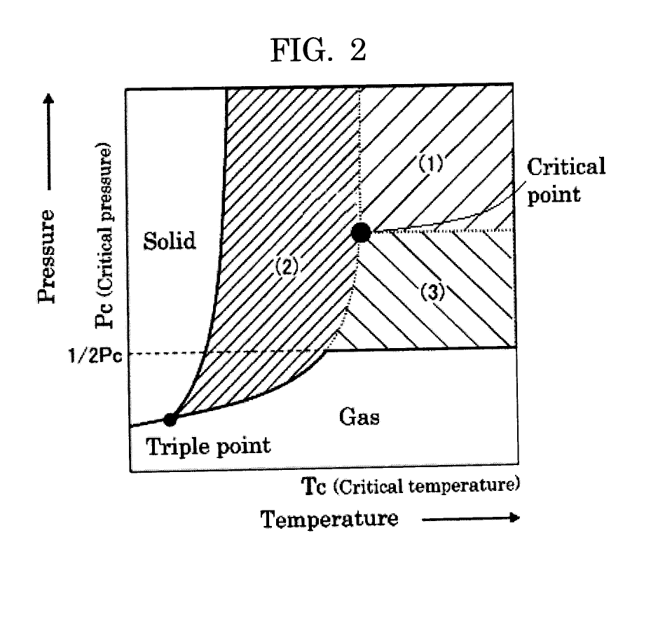

The compressive fluid will be explained with reference to FIGS. 1 and 2. FIG. 1 is a general phase diagram depicting the state of a substance depending on pressure and temperature conditions. FIG. 2 is a phase diagram which defines the compressive fluid.

The “compressive fluid” refers to a state of a substance present in any one of the regions (1), (2) and (3) of FIG. 2 in the phase diagram of FIG. 1.

The “compressive fluid” refers to a state of a fluid present in any one of the regions (1), (2) and (3) of FIG. 2 in the phase diagram of FIG. 1.

In such regions, the substance is known to have extremely high density and show different behaviors from those shown at normal temperature and normal pressure. Note that, the substance is a supercritical fluid when it is present in the region (1). The supercritical fluid is a fluid that exists as a non-condensable high-density fluid at temperature and pressure exceeding a limiting point (critical point) at which a gas and a liquid can coexist and that does not condense even when it is compressed. When the substance is in the region (2), the substance is a liquid, but in the present invention, it is a liquefied gas obtained by compressing a substance existing as a gas at normal temperature (25° C.) and normal pressure (1 atm). When the substance is in the region (3), the substance is in the state of a gas, but in the present invention, it is a high-pressure gas of which pressure is ½ or more of the critical pressure (Pc), i.e. ½ Pc or higher.

Examples of a substance constituting the compressive fluid include carbon monoxide, carbon dioxide, dinitrogen monooxide, nitrogen, methane, ethane, propane, 2,3-dimethylbutane, and ethylene. Among them, carbon dioxide is preferable because the critical pressure and critical temperature of carbon dioxide are respectively about 7.4 MPa and about 31° C., and thus a supercritical state of carbon dioxide is easily formed. In addition, carbon dioxide is non-flammable, and therefore it is easily handled.

The compressive fluid may be used alone or in combination of two or more as a mixture.

Organic solvents such as alcohols (e.g., methanol, ethanol, and propanol), ketones (e.g., acetone, and methyl ethyl ketone), toluene, ethyl acetate, and tetrahydrofuran may be added as an entrainer (co-solvent).

According to a method for producing a thermoplastic polyimide of the present invention, a thermoplastic polyimide including a repeating unit represented by the General Formula I, wherein an amount of an organic solvent in the thermoplastic polyimide detected by gas chromatography is 5 ppm by mass or less; a thermoplastic polyimide including a repeating unit represented by the General Formula II, wherein an amount of an organic solvent in the thermoplastic polyimide detected by gas chromatography is 5 ppm by mass or less; and a thermoplastic polyimide including a repeating unit represented by the Structural Formula I, wherein an amount of an organic solvent detected in the thermoplastic polyimide by gas chromatography is 5 ppm by mass or less, can be produced. An organic solvent having high boiling temperature is not used in the thermoplastic polyimide. Alternatively, in cases where the organic solvent having high boiling temperature is used therein, a small amount thereof can be added thereto as an additive.

In the present invention, the tetracarboxylic dianhydride is subjected to a (polyaddition) reaction with the diamine compound by mixing and heating these compounds in a compressive fluid, to thereby produce polyamic acid. The resultant polyamic acid is subjected to normal pressure, and is discharged from an injection nozzle, to thereby obtain polyamic acid particles. Alternatively, the polyamic acid is heated and imidated in the compressive fluid to thereby convert it into a thermoplastic polyimide. The resultant thermoplastic polyimide is subjected to normal pressure, and is discharged from an injection nozzle, to thereby obtain thermoplastic polyimide particles.

In the present invention, the tetracarboxylic dianhydride is subjected to a (polyaddition) reaction with the diisocyanate compound by mixing and heating these compounds in a compressive fluid to thereby produce a thermoplastic polyimide. The resultant thermoplastic polyimide is subjected to normal pressure, and is discharged from an injection nozzle, to thereby produce thermoplastic polyimide particles.

The thermoplastic polyimide particles can allow a surface to be coated with polyimide by applying the thermoplastic polyimide particles in a powder state or as a dispersion in a solvent having a low boiling point onto the surface, followed by heating the particles.

A thermoplastic polyimide of the present invention contains substantially no organic solvent, and has high quality. Thus, it is widely and suitably used for, for example, an insulating material of an electronic circuit substrate, a frictional part spacer, a metal, an alternate material of ceramics, a film, a varnish, an adhesive, and a bulk molding material.

### (Thermoplastic Polyimide Foam Body)

A thermoplastic polyimide foam body of the present invention can be obtained by foaming a thermoplastic polyimide produced by a method for producing the thermoplastic polyimide.

The thermoplastic polyimide foam body is preferably obtained by foaming the thermoplastic polyimide in a compressive fluid. By using the compressive fluid without using a chemical foaming agent, an amount of impurities found in the resultant thermoplastic polyimide can be reduced to a slight amount, and thus the thermoplastic foam body having uniformly micro holes can be obtained.

### (Method for Producing Thermoplastic Polyimide Foam Body)

A method for producing a thermoplastic polyimide foam body of the present invention, the method includes;

reacting tetracarboxylic dianhydride with a diisocyanate compound, a diamine compound, or both thereof in a compressive fluid, to thereby obtain a thermoplastic polyimide; and

foaming the obtained thermoplastic polyimide under reduced pressure, and further includes other steps if necessary.

A thermoplastic polyimide can be obtained without using a chemical foaming agent by synthesizing polyamic acid in the compressive fluid, to thereby imidate polyamic acid. In addition, a step of synthesizing polyamic acid to a step of foaming of the thermoplastic polyimide can be performed in one step, and thus the step of foaming the thermoplastic polyimide can be greatly simplified compared with the conventional steps.

Here, a producing device used in a method for producing a thermoplastic polyimide and a method for producing a thermoplastic polyimide form body of the present invention will be described with reference to figures.

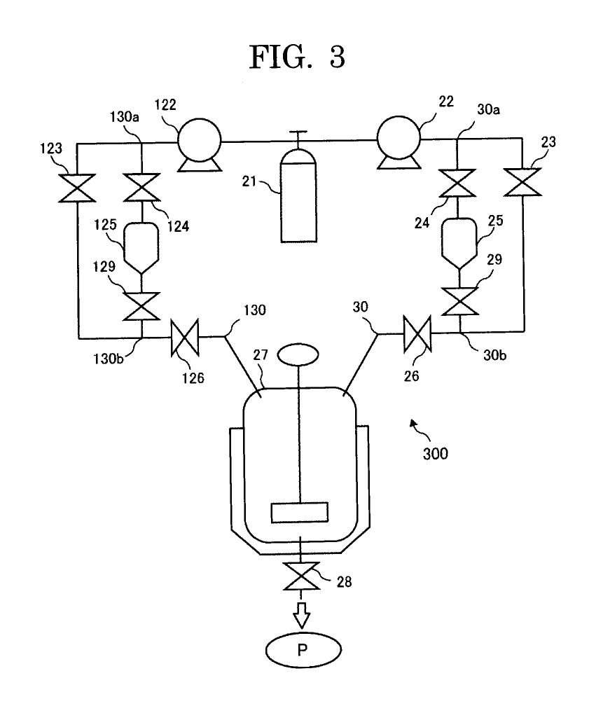

First, a polymerization reactor used in a batch manner will be described. In the system diagram of FIG. 3, a polymerization reactor 300 contains a tank 21, a metering pump 22, an addition pot 25, a reaction vessel 27, and valves (23, 24, 26, 28, and 29). They are connected with each other via a pressure resistant pipe 30, as illustrated in FIG. 3. Moreover, couplings (30a and 30b) are provided to the pipe 30.

Meanwhile, a pipe 130 provided with an addition pot 125, valves (123, 124, 126, and 129), and couplings (130a and 130b); a metering pump 122, and an addition pot 125 are provided.

The tank 21 stores a compressive fluid. Note that, the tank 21 may contain gas or solid that is transformed into the compressive fluid upon application of heat or pressure in a supply path through which it is supplied to the reaction vessel 27, or in the reaction vessel 27. In this case, the gas or solid stored in the tank 21 is transformed into the state of (1), (2), or (3) in the phase diagram of FIG. 2 in the reaction vessel 27 by applying heat or pressure.

The metering pump 22 supplies the compressive fluid stored in the tank 21 to the reaction vessel 27 at constant pressure and flow rate. The addition pot 25 stores tetracarboxylic dianhydride represented by the General Formula (1). By opening and closing each of the valves (23, 24, 26, and 29), the path is switched between a path for supplying the compressive fluid stored in the tank 21 to the reaction vessel 27 via the addition pot 25, and a path for supplying the compressive fluid to the reaction vessel 27 without passing through the addition pot 25.

The metering pump 122 supplies the compressive fluid stored in the tank 21 to the reaction vessel 27 at constant pressure and flow rate. The addition pot 125 stores a diamine compound represented by the General Formula (2). By opening and closing each of the valves (123, 124, 126, and 129), the path is switched between a path for supplying the compressive fluid stored in the tank 21 to the reaction vessel 27 via the addition pot 125, and a path for supplying the compressive fluid to the reaction vessel 27 without passing through the addition pot 125.

The reaction vessel 27 is a pressure resistant vessel configured to bring the compressive fluid supplied from the tank 21, the tetracarboxylic dianhydride supplied from the addition pot 25, and the diamine compound supplied from the addition pot 125 into contact with each other, to thereby allow tetracarboxylic dianhydride to react with the diamine compound. The reaction vessel 27 may be provided with a gas outlet for releasing evaporated materials. Moreover, the reaction vessel 27 contains a heater for heating raw materials and the compressive fluid. Further, the reaction vessel 27 contains a stirring device for stirring the raw materials and compressive fluid. The stirring device can realize a uniform and quantitative polymerization reaction as it can prevent sedimentation of the resultant reaction product caused by a difference in concentration between the raw materials and the resultant reaction product. The valve 28 discharges the polymer product P in the reaction vessel 27 by opening after the completion of the polymerization reaction.

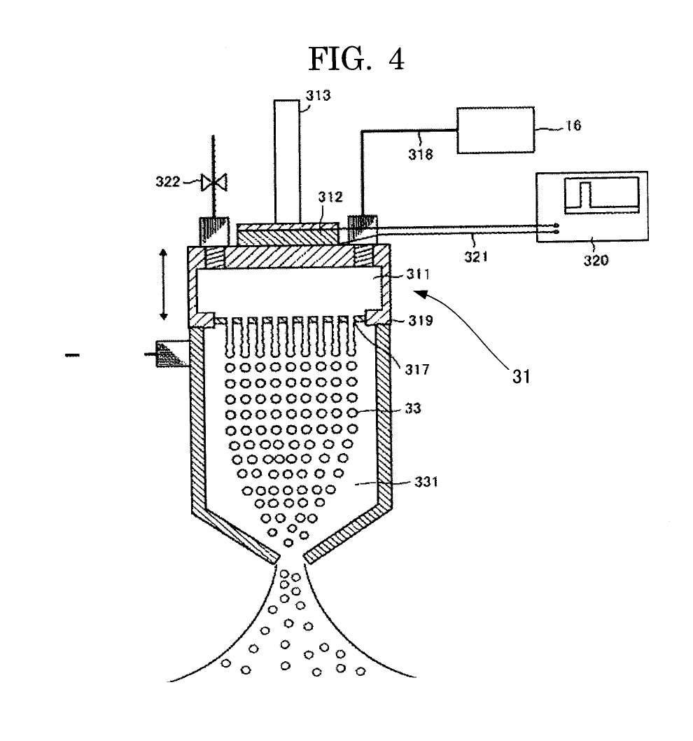

Next, a discharging device 31 and a particle forming section 331 will be described with reference to FIG. 4. FIG. 4 is a schematic diagram showing one exemplary discharging device 31 and particle forming section 331.

The discharging device 31 contains a reservoir 311 configured to reserve a reaction product, one or more through holes 317 formed on a part of a wall of the reservoir 311, a vibrating unit 312 provided so as to be in contact with the reservoir 311 in order to apply vibration to the through holes 317, a signal generator 320 connected with the vibrating unit 312 via an electroconductive wire 321, and a supporting unit 313 configured to hold the vibrating unit 312.

In the discharging device 31, one or more through holes 317 are provided relative to one vibrating unit 312. The vibrating unit 312 is provided so as to be in contact with the reservoir 311 in order to apply vibration to the through holes 317. Such configuration allows the reservoir 311 and the through holes 317 to be vibrated from outside while the vibrating unit 312 is placed under a normal pressure environment. That is, a high pressure fluid can be pulverized into particles without using a special vibrating unit.

Example of the discharging device 31 includes a device containing a reaction product supplying unit 16 configured to quantitatively supply to the reservoir 311 a reaction product (polyamic acid or a polyimide resin) to be discharged through the through holes 317, as shown in FIG. 4. A granular material 33 is indicated in FIG. 4.

In the case where it is connected to the polymerization reactor 300 shown in FIG. 3 to continuously produce polyimide resin particles, instead of the reaction product supplying unit 16, the reaction container 27 of the polymerization reactor 300 shown in FIG. 3 may be connected to the reservoir 311 via a valve 28 and a pipe 318 to supply the reaction product.

The reservoir 311 and a pipe for connecting the reservoir 311 is formed of a metal member such as SUS (stainless steel) preferably having a pressure resistance of about 30 MPa because the reaction product is required to be kept in a highly pressurized state. The reservoir 311 is connected with a pipe 318 configured to supply the reaction product, and preferably contain a mechanism 319 configured to hold a plate on which the through holes 317 are formed. The vibrating unit 312 configured to vibrate the entire reservoir 311 is in contact with the reservoir 311. The vibrating unit 312 is preferably connected with the signal generator 320 via the electroconductive wire 321 so that its vibration is controlled by signal generated by the signal generator 320. The reservoir 311 is preferably provided with an open valve 322 in order to adjust internal pressure thereof, from the viewpoint of stable formation of a columnar reaction product.

From the viewpoint of uniform application of vibration, the entire reservoir 311 containing the through holes 317 is preferably vibrated by one vibrating unit 312. The vibrating unit 312 configured to vibrate the reservoir 311 is not particularly limited and may be appropriately selected, as long as it can surely apply vibration preferably at a constant number of vibrations (may be referred to as frequency). The vibrating unit 312 is preferably formed of a piezoelectric material in order to vibrate the through holes at a constant frequency through contraction.

The piezoelectric material has a function to convert electric energy to mechanical energy. Specifically, the piezoelectric material can be contracted by applying voltage to thereby vibrate the through holes. Example of the type of the piezoelectric material includes piezoelectric ceramics such as lead zirconate titanate (PZT), which is often used in the form of laminate because it typically has a small displacement amount. Other types of the piezoelectric material include piezoelectric polymer (e.g., polyvinylidene fluoride (PVDF)), and a single crystal of quartz, LiNbO₃, LiTaO₃, or KNbO₃.

A frequency of the signal applied to the piezoelectric material is not particularly limited and may be appropriately selected depending on the intended purpose, but is preferably 20 kHz to 10 MHz, more preferably 50 kHz to 1 MHz from the viewpoint of production of fine reaction product particles having extremely uniform particle diameters. When the frequency is less than 20 kHz, productivity may be deteriorated. When the frequency is more than 10 MHz, particle diameter controlling property may be deteriorated.

The vibration unit 312 is in contact with the reservoir 311, and the reservoir 311 holds a plate on which the through holes 317 are formed. The vibration unit 312 is most preferably arranged in parallel to the wall of the reservoir 311 on which the through holes 317 are formed, from the viewpoint of uniformly applying vibration to a columnar body discharged through the through holes 317. Even though the wall of the reservoir deforms in the course of vibration, the inclination therebetween is preferably 10° or less. From the viewpoint of further improvement of productivity, it is preferred to provide a plurality of the reservoirs 311 each including the vibration unit 312.

The supporting unit 313 is provided to fix the reservoir 311 and the vibration unit 312 to the discharge device 31. The material of the supporting unit 313 is not particularly limited and may be appropriately selected depending on the intended purpose, but it is preferably rigid, such as metal. If necessary, for example, a rubber material or a resin material as a vibrational relaxation material may be partly provided in order to prevent disturbance of the vibration of the reservoir caused by excess sympathetic vibration.

The through hole 317 is a space through which the reaction product supplied from the reaction product supplying unit 16 is discharged in a columnar form. The material of a member in which the through holes 317 are formed is not particularly limited and may be appropriately selected depending on the intended purpose. Examples thereof include stainless steel (SUS), nickel, copper, aluminum, iron, and titanium. Among them, stainless steel (SUS) and nickel are preferred, in terms of corrosion resistance.

The thickness of the member in which the through holes 317 are formed is not particularly limited and may be appropriately selected depending on the intended purpose, but it is preferably 5 μm to 100 μM. When the thickness is more than 100 μm, it may be difficult to form the through holes 317 in the member. When the thickness is less than 5 μm, the member may be broken due to a difference in pressure between the reservoir 311 and the particle forming section 331. Note that, the thickness of the member is not limited to the above-mentioned range, as long as the through holes 317 can be formed therein, and sufficient durability can be obtained depending on the material of the member.

The opening diameter of the through hole 317 is not particularly limited, as long as the pressure upon discharging can maintain at a constant level. When the opening diameter of the through hole is excessively small, the through hole 317 is easily clogged with the reaction product, and it may be difficult to obtain desired particles. The upper limit of the opening diameter of the through hole is not limited, and the lower limit thereof is preferably 2 μm or larger, more preferably 5 μm or larger, particularly preferably 8 μm or larger. Note that, the opening diameter means a diameter of the through hole 317 when the through hole is circular, and a minor axis of the through hole 317 when the through hole is elliptic.

The particles can be produced even when only one through hole 317 is provided. However, from the viewpoint of effectively producing the particles having extremely uniform diameters, it is preferred that a plurality of through holes 317 be provided. The number of the through holes 317 per one reservoir 311, to which the vibration is applied with one vibration unit 312, is preferably 10 to 10,000, more preferably 10 to 1,000 from the viewpoint of productivity and controllability, and in order to surely produce fine particles having extremely uniform diameters. Note that, from the viewpoint of operability, the number of the through holes 317 operated by one vibration unit 312, namely, the number of the through holes 317 formed in one reservoir 311 is preferably as large as possible. However, when the number of thereof is large without restriction, uniformity of the particle diameters may not be maintained.

### EXAMPLES

The present invention will be described with reference to the following Examples. However, it should be noted that the present invention is not limited to these Examples.

In Examples and Comparative Examples, methods for measuring “a weight average molecular weight (Mw), a number average molecular weight (Mn), and a ratio (Mw/Mn) of a polyimide resin”, “permittivity of a polyimide resin”, and “an amount of an organic solvent” are as follows.

### <Weight Average Molecular Weight (Mw), Number Average Molecular Weight (Mn), and Ratio (Mw/Mn) of Polyimide Resin>

Polyimide resin was dissolved in a NMP/DMF solvent, and the resultant mixture was measured using “HCC-8320” (device name, product of TOSOH CORPORATION) by gel permeation chromatography method, to thereby determine a weight average molecular weight (Mw), a number average molecular weight (Mn), and a ratio (Mw/Mn) of the polyimide resin.

### <Permittivity of Polyimide Resin>

An electrostatic capacity (F) of the polyimide resin was measured at 1 kHz using “LCR meter 4284A” (device name, product of Yokogawa-Hewlett-Packard Company), to thereby determine permittivity thereof based on the following formula.

Permittivity (ε)=[electrostatic capacity (F)×film thickness of sample (m)]/[permittivity of vacuum×area of upper electrode (m²)]

### <Amount of Organic Solvent>

An amount of an organic solvent in the polyimide resin was measured as follows by a gas chromatograph apparatus (GC14A, product of SHIMADZU CORPORATION).

First, a polyimide resin film as a measurement sample was purged with nitrogen career gas for 30 minutes while a temperature of injection port of the apparatus was kept to 350° C. Then, the vaporized solvent component was trapped in a packed column in a state of normal temperature. The trapped organic solvent was directly analyzed for gas chromatograph by a FID detector, and then an amount of the organic solvent in the polyimide resin film was analyzed based on direct calibration curve method. A packed column having an internal diameter of 3 mm×1.6 mm, which is made of a glass; “TENAX-TA” (product name, product of GL Sciences Inc.) as a filler; and nitrogen as a career gas were used.

### Example 1

A 500 mL of jacket-type stainless steel pressure container was charged with 176.53 g of diphenyl-3,3′,4,4′-tetracarboxylic dianhydride (0.6 mol) and 151.33 g of diphenyl ether-2,4′-diisocyanate (0.6 mol). Next, several drops of pyridine, serving as a reaction activator, were added thereto. A lid of the container was closed, and then carbon dioxide was charged thereinto through a pipe connected with the jacket-type stainless steel pressure container so that an internal pressure thereof reached 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction to proceed, silicone oil, serving as a heating medium, was added thereto and was circulated so that the contents in the jacket-type stainless steel pressure container reached 180° C. In this state, the mixture was heated and stirred for 2 hours, and then the reaction was terminated.

Then, while the mixture was being heated, carbon dioxide was supplied to the jacket-type stainless steel pressure container by a leak valve so that an internal pressure thereof was kept to 8 MPa, and then the pressure was reduced for 10 minutes in a state where the leak valve was opened. Immediately after that, the pressure therein was reduced to normal pressure. According to the above procedure, a brown foamed solid matter (thermoplastic polyimide foam body) was obtained.

A polyimide resin in the obtained thermoplastic polyimide foam body was found to have a number average molecular weight (Mn) of 95,000, a weight average molecular weight (Mw) of 162,000, a ratio (Mw/Mn) of 1.7, permittivity of 2.2, and an amount of the organic solvent of 1 ppm by mass. The polyimide resin was measured based on melt mass flow rate (MFR), and as a result it indicated thermoplasticity.

### Example 2

A 500 mL of jacket-type stainless steel pressure container was charged with 176.53 g of diphenyl-3,3′,4,4′-tetracarboxylic dianhydride (0.6 mol), 164.20 g of 2,2-bis[4-(4-aminophenoxy)phenyl]propane (0.4 mol), and 58.47 g of 1,4-bis(4-aminophenoxy)benzene (0.2 mol). Next, several drops of pyridine serving as a reaction activator was added thereto. A lid of the container was closed, and then carbon dioxide was charged thereinto through a pipe connected with the jacket-type stainless steel pressure container so that an internal pressure thereof was 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction proceed, silicone oil, serving as a heating medium, was added thereto and was circulated so that the contents in the jacket-type stainless steel pressure container reached 180° C. In this state, the mixture was stirred and mixed for 2 hours, and then the reaction was terminated.

Then, while the mixture was being heated, carbon dioxide was supplied to the jacket-type stainless steel pressure container by a leak valve so that an internal pressure thereof was kept to 8 MPa, and then the pressure was reduced for 10 minutes in a state where the leak valve was opened, to thereby discharge water in the jacket-type stainless steel pressure container into outside of the system. Then, a pressure therein was reduced to normal pressure for 1 hour. According to the above procedure, a brown foamed solid matter (thermoplastic polyimide foam body) was obtained.

A polyimide resin in the obtained thermoplastic polyimide foam body was found to have a number average molecular weight (Mn) of 120,000, a weight average molecular weight (Mw) of 216,000, a ratio (Mw/Mn) of 1.8, permittivity of 3.7, an amount of the organic solvent of 3 ppm by mass. The polyimide resin was measured based on melt mass flow rate (MFR), and as a result it indicated thermoplasticity.

### Example 3

A 500 mL of jacket-type stainless steel pressure container was charged with 176.06 g of diphenyl-3,3′,4,4′-tetracarboxylic dianhydride (0.595 mol), 164.20 g of 2,2-bis[4-(4aminophenoxy)phenyl]propane (0.4 mol), and 58.47 g of 1,4-bis(4-aminophenoxy)benzene (0.2 mol). Next, several drops of pyridine, serving as a reaction activator, were added thereto. A lid of the container was closed, and then carbon dioxide was charged thereinto through a pipe connected with the jacket-type stainless steel pressure container so that an internal pressure thereof reached 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction to proceed, silicone oil, serving as a heating medium, was added thereto and was circulated so that the contents in the jacket-type stainless steel pressure container reached 180° C. In this state, the mixture was heated and stirred for 2 hours, and then the reaction was terminated.

Then, the jacket-type stainless steel pressure container was charged with 7.41 g of phthalic anhydride (0.05 mol) from a separated container set on the top of the jacket-type stainless steel pressure container in order to prevent reduction in an internal pressure of the container. The mixture was heated and stirred for 0.5 hours, circulation of the heating medium was terminated, to thereby terminate polymerization. Then, while the mixture was being heated, carbon dioxide was supplied to the jacket-type stainless steel pressure container by a leak valve so that an internal pressure thereof was kept to 8 MPa, and then the pressure was reduced for 10 minutes in a state where the leak valve was opened, to thereby discharge water in the jacket-type stainless steel pressure container into outside of the system. Immediately after that, a pressure therein was reduced to normal pressure for 1 hour. According to the above procedure, a brown foamed solid matter (thermoplastic polyimide foam body) was obtained.

A polyimide resin in the obtained thermoplastic polyimide foam body was found to have a number average molecular weight (Mn) of 70,000, a weight average molecular weight (Mw) of 112,000, a ratio (Mw/Mn) of 1.6, permittivity of 3.8, and an amount of the organic solvent of 5 ppm by mass. The polyimide resin was measured based on melt mass flow rate (MFR), and as a result it indicated thermoplasticity.

### Example 4

A 500 mL of jacket-type stainless steel pressure container was charged with 176.53 g of diphenyl-3,3′,4,4′-tetracarboxylic dianhydride (0.6 mol), 164.20 g of 2,2-bis[4-(4aminophenoxy)phenyl]propane (0.2 mol), 58.47 g of 1,4-bis(4-aminophenoxy)benzene and 225.22 g of diphenyl ether-2,4′-diisocyanate (0.1 mol). Next, several drops of pyridine, serving as a reaction activator, were added thereto. A lid of the container was closed, and then carbon dioxide was charged thereinto through a pipe connected with the jacket-type stainless steel pressure container so that an internal pressure thereof reached 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction to proceed, silicone oil, serving as a heating medium, was added thereto and was circulated so that the contents in the jacket-type stainless steel pressure container reached 180° C. In this state, the mixture was heated and stirred for 2 hours, and then the reaction was terminated.

Then, while the mixture was being heated, carbon dioxide was supplied to the jacket-type stainless steel pressure container by a leak valve so that an internal pressure thereof was kept to 8 MPa, and then the pressure was reduced for 10 minutes in a state where the leak valve was opened, to thereby discharge water in the jacket-type stainless steel pressure container into outside of the system. Immediately after that, a pressure therein was reduced to normal pressure for 1 hour. According to the above procedure, a brown foamed solid matter (thermoplastic polyimide foam body) was obtained.

A polyimide resin in the obtained thermoplastic polyimide foam body was found to have a number average molecular weight (Mn) of 105,000, a weight average molecular weight (Mw) of 178,500, a ratio of (Mw/Mn) of 1.7, permittivity of 3.8, and an amount of the organic solvent of 4 ppm by mass. The polyimide resin was measured based on melt mass flow rate (MFR), and as a result it indicated thermoplasticity.

### Example 5

A 500 mL of jacket-type stainless steel pressure container was charged with 176.53 g of diphenyl-3,3′,4,4′-tetracarboxylic dianhydride (0.6 mol), 164.20 g of 2,2-bis[4-(4aminophenoxy)phenyl]propane (0.2 mol), 58.47 g of 1,4-bis(4-aminophenoxy)benzene (0.2 mol), and 24.22 g of diphenyl ether-2,4′-diisocyanate (0.1 mol). Next, several drops of pyridine, serving as a reaction activator, were added thereto. A lid of the container was closed, and then carbon dioxide was charged thereinto through a pipe connected with the jacket-type stainless steel pressure container so that an internal pressure thereof reached 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction to proceed, silicone oil, serving as a heating medium, was added thereto and was circulated so that the contents in the jacket-type stainless steel pressure container reached 180° C. In this state, the mixture was heated and stirred for 2 hours, and then the reaction was terminated.

Then, while the mixture was being heated, carbon dioxide was supplied to the jacket-type stainless steel pressure container by a leak valve so that an internal pressure thereof was kept to 8 MPa, and the pressure was reduced for 10 minutes in a state where the leak valve was opened, to thereby discharge water in the jacket-type stainless steel pressure container into outside of the system. Immediately after that, the pressure therein was reduced to normal pressure. According to the above procedure, a brown foamed solid matter (thermoplastic polyimide foam body) was obtained.

A polyimide resin in the obtained thermoplastic polyimide foam body was found to have a number average molecular weight (Mn) of 120,000, a weight average molecular weight (Mw) of 216,000, a ratio (Mw/Mn) of 1.8, permittivity of 2.2, and an amount of the organic solvent of 4 ppm by mass. The polyimide resin was measured based on melt mass flow rate (MFR), and as a result it indicated thermoplasticity.

### Comparative Example 1

A 500 mL of jacket-type stainless steel pressure container was charged with 176.53 g of diphenyl-3,3′,4,4′-tetracarboxylic dianhydride (0.6 mol) and 120.15 g of 4,4′-diamino diphenyl ether (0.6 mol). Next, several drops of pyridine, serving as a reaction activator, were added thereto. A lid of the container was closed, and then carbon dioxide was charged thereinto through a pipe connected with the jacket-type stainless steel pressure container so that an internal pressure thereof reached 8 MPa indicated by a pressure gauge set on the top of the jacket-type stainless steel pressure container.

Then, the materials were kneaded using a magnetic impeller which was set in the jacket-type stainless steel pressure container, and was subjected to TEFLON (registered trademark) coating. The magnetic impeller subjected to TEFLON (registered trademark) coating was rotatable by an externally provided electromagnetic motor. Moreover, in order to allow reaction to proceed, silicone oil, serving as a heating medium, was added thereto and was circulated so that the contents in the jacket-type stainless steel pressure container reached 180° C. In this state, the mixture was heated and stirred for 2 hours, and then the reaction was terminated.

Next, carbon dioxide was discharged from a leak valve until an internal pressure in the jacket-type stainless steel pressure container reached normal pressure. According to the above procedure, a yellow, powdery, fragile solid matter (thermoplastic polyimide foam body) was obtained.

The obtained foamed solid matter was found to have a number average molecular weight (Mn) of 1,100, a weight average molecular weight (Mw) of 1,210, a ratio (Mw/Mn) of 1.1, unmeasurable permittivity, and an amount of the organic solvent of 8 ppm by mass.

In the Comparative Example 1,4,4′-diamino diphenyl ether which is a diamine compound, was para-form compound and thus the obtained polyimide was insoluble in a supercritical fluid. As a result, polymerization of the high molecular weight polymer didn't proceed, and thus a fragile foamed solid matter having a small molecular weight was formed.

### Comparative Example 2

A 500 mL of separable flask was charged with 17.65 g of diphenyl-3,3′,4,4′-tetracarboxylic dianhydride (0.06 mol), 16.42 g of 2,2-bis[4-(4aminophenoxy)phenyl]propane (0.04 mol), and 5.85 g of 1,4-bis(4-aminophenoxy)benzene (0.02 mol).

Next, 266 g of N-methyl2pyrrolidone and 20 g of a dehydrating agent were charged into the flask. Next, several drops of pyridine, serving as a reaction activator, were added thereto. An impeller, a separable cover, and a condenser were set to the flask, and then nitrogen was charged into the separable flask at a rate of 0.1 mL/min.

Then, the resultant mixture was heated in an oil bath at 180° C. In this state, the mixture was heated and stirred for 2 hours, and then the reaction was terminated.

The obtained polyimide was found to have a number average molecular weight (Mn) of 115,000, a weight average molecular weight (Mw) of 61,000, and a Mw/Mn of 1.89.

A solution containing this polyimide was casted onto a release-treated stainless substrate, and then the substrate was gradually hearted and dried to 250° C., to thereby volatilize the solvent. The polyimide was found to have an amount of the organic amount of 1,000 ppm by mass.

TABLE 1-1

| | | Examples | | | | |
|---|---|---|---|---|---|---|
| Components (mol) | | 1 | 2 | 3 | 4 | 5 |
| Tetracarboxylic | Diphenyl-3,3′,4,4′- | 0.6 | 0.6 | 0.595 | 0.6 | 0.6 |
| dianhydride | tetracarboxylic dianhydride | | | | | |
| Diisocyanate | Diphenyl ether-2,4′- | 0.6 | — | — | 0.1 | 0.1 |
| compound | diisocyanate | | | | | |
| Diamine | 2,2-Bis[4(4-aminophenoxy) | — | 0.4 | 0.4 | 0.2 | 0.2 |
| compounds | phenyl]propane | | | | | |
| | 1,4-Bis(4-aminophenoxy) | — | 0.2 | 0.2 | 0.2 | 0.2 |
| | benzene | | | | | |
| | 4,4′-Diaminodiphenyl ether | — | — | — | — | — |

TABLE 1-2

| | | Comparative | |
|---|---|---|---|
| | | Examples | |
| Components (mol) | | 1 | 2 |
| Tetracarboxylic | Diphenyl-3,3′,4,4′-tetracarboxylic | 0.6 | 0.06 |
| dianhydride | dianhydride | | |
| Diisocyanate | Diphenyl ether-2,4′-diisocyanate | — | — |
| compound | | | |
| Diamine | 2,2-Bis[4-(4- | — | 0.04 |
| compounds | aminophenoxy)phenyl]propane | | |
| | 1,4-Bis(4-aminophenoxy)benzene | — | 0.02 |
| | 4,4′-Diaminodiphenyl ether | 0.6 | — |

### Diphenyl-3,3′,4,4′-tetracarboxylic dianhydride

### Product of Ube Industries, Ltd.

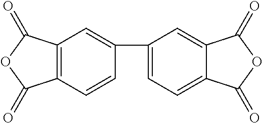 [SMILES: O=C1OC(=O)c2cc(-c3ccc4c(c3)C(=O)OC4=O)ccc21]

### Diphenyl ether-2,4′-diisocyanate

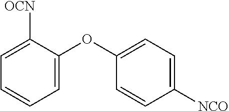

### 2,2-Bis[4-(4-aminophenoxy)phenyl]propane

### Product of Wakayama Seika Kogyo., Ltd.

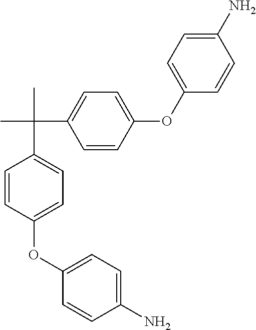 [SMILES: CC(C)(c1ccc(Oc2ccc(N)cc2)cc1)c1ccc(Oc2ccc(N)cc2)cc1]

### 1,4-Bis(4-aminophenoxy)benzene

### Product of Wakayama Seika Kogyo., Ltd.

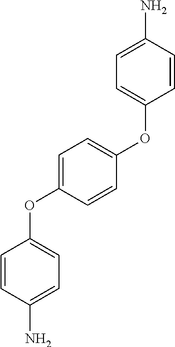 [SMILES: Nc1ccc(Oc2ccc(Oc3ccc(N)cc3)cc2)cc1]

### 4,4′-Diaminodiphenyl ether

### Product of Wakayama Seika Kogyo., Ltd.

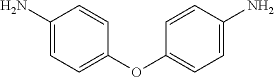 [SMILES: Nc1ccc(Oc2ccc(N)cc2)cc1]

TABLE 2

| | | Number | Weight | | | |
|---|---|---|---|---|---|---|
| | | average | average | | Amount | |
| | | molecular | molecular | | of | |
| | | weight | weight | Mw/ | organic | |
| | | (Mn) | (Mw) | Mn | solvent | Permittivity |
| Examples | 1 | 95,000 | 162,000 | 1.7 | 1 | 2.2 |
| | 2 | 120,000 | 216,000 | 1.8 | 3 | 3.7 |
| | 3 | 70,000 | 112,000 | 1.6 | 5 | 3.8 |
| | 4 | 105,000 | 178,500 | 1.7 | 4 | 3.8 |
| | 5 | 120,000 | 216,000 | 1.8 | 4 | 2.2 |
| Comparative | 1 | 1,100 | 1,210 | 1.1 | 8 | Unmeasurable |
| Examples | 2 | 115,000 | 61,000 | 1.89 | 1,000 | |

Embodiments of the present invention are as follows.

<1> A thermoplastic polyimide, including:

a repeating unit represented by the following General Formula I,

wherein an amount of an organic solvent in the thermoplastic polyimide detected by gas chromatography is 5 ppm by mass or less,

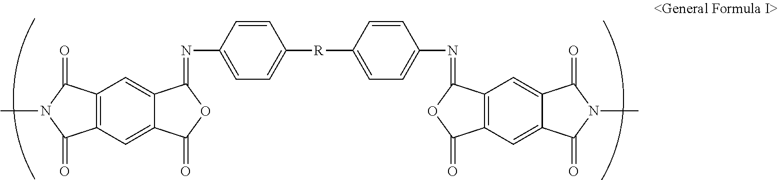

where in the General Formula I, R represents a divalent organic group.

<2> A thermoplastic polyimide, including:

a repeating unit represented by the following General Formula II,

wherein an amount of an organic solvent detected in the thermoplastic polyimide by gas chromatography is 5 ppm by mass or less,

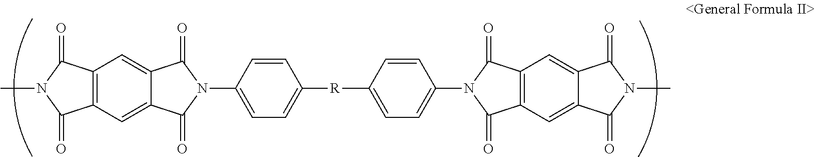

where in the General Formula II, R represents a divalent organic group.

<3> A thermoplastic polyimide, including:

a repeating unit represented by the following Structural Formula I,

wherein an amount of an organic solvent detected in the thermoplastic polyimide by gas chromatography is 5 ppm by mass or less.

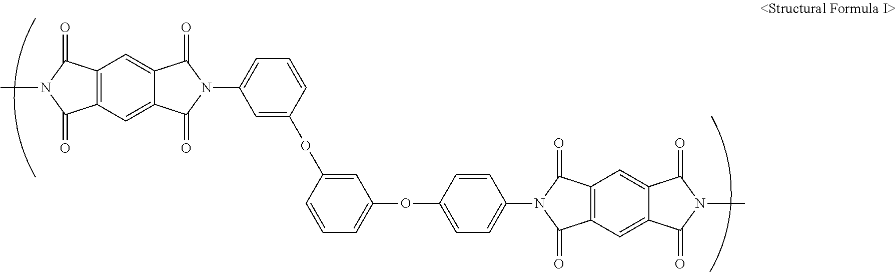

<4> The thermoplastic polyimide according to any one of <1> to <3>, wherein a weight average molecular weight (Mw) of the thermoplastic polyimide measured by gel permeation chromatography is 10,000 to 1,000,000, and wherein a ratio (Mw/Mn) of the weight average molecular weight (Mw) to a number average molecular weight (Mn) of the thermoplastic polyimide is 1.0 to 2.0.
<5> The thermoplastic polyimide according to any one of <1> to <4>, wherein permittivity of the thermoplastic polyimide is 2.0 or more.
<6> A method for producing the thermoplastic polyimide according to any one of <1> to <5>, the method including:

reacting tetracarboxylic dianhydride with a diisocyanate compound, a diamine compound, or both thereof in a compressive fluid.

<7> The method for producing the thermoplastic polyimide according to <6>, wherein the reacting is performed at 180° C. or less.
<8> The method for producing the thermoplastic polyimide according to any one of <6> to <7>, wherein the diamine compound is a meta-form aromatic diamine compound containing two or more ether bonds.
<9> A thermoplastic polyimide foam body,

wherein the thermoplastic polyimide foam body is obtained by foaming the thermoplastic polyimide according to any one of <1> to <5>.

<10> A method for producing the thermoplastic polyimide foam body according to <9>, the method including:

reacting tetracarboxylic dianhydride with a diisocyanate compound, a diamine compound, or both thereof in a compressive fluid, to thereby obtain a thermoplastic polyimide, and

foaming the obtained thermoplastic polyimide under reduced pressure.

This application claims priority to Japanese application No. 2014-101980, filed on May 16, 2014 and incorporated herein by reference.

What is claimed is:

1. A thermoplastic polyimide, comprising:
a repeating unit represented by the following General Formula I,
wherein an amount of an organic solvent in the thermoplastic polyimide detected by gas chromatography is 5 ppm by mass or less, 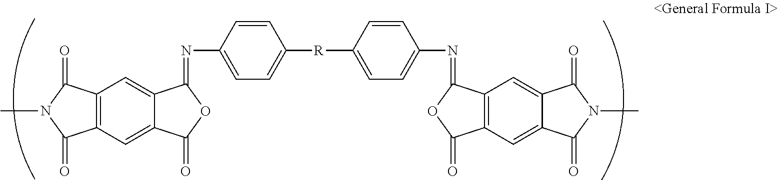
where in the General Formula I, R represents a divalent organic group.

2. The thermoplastic polyimide according to claim 1, wherein a weight average molecular weight (Mw) of the thermoplastic polyimide measured by gel permeation chromatography is 10,000 to 1,000,000, and wherein a ratio (Mw/Mn) of the weight average molecular weight (Mw) to a number average molecular weight (Mn) of the thermoplastic polyimide is 1.0 to 2.0.

3. The thermoplastic polyimide according to claim 1, wherein permittivity of the thermoplastic polyimide is 2.0 or more.

4. A thermoplastic polyimide, comprising:
a repeating unit represented by the following General Formula II,
wherein an amount of an organic solvent detected in the thermoplastic polyimide by gas chromatography is 5 ppm by mass or less, 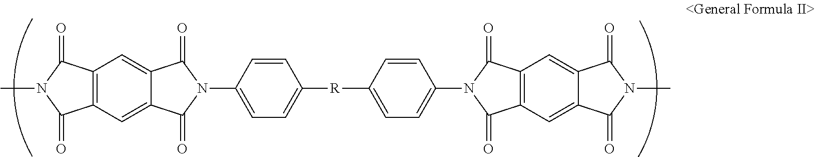
where in the General Formula II, R represents a divalent organic group.

5. The thermoplastic polyimide according to claim 4, wherein a weight average molecular weight (Mw) of the thermoplastic polyimide measured by gel permeation chromatography is 10,000 to 1,000,000, and wherein a ratio (Mw/Mn) of the weight average molecular weight (Mw) to a number average molecular weight (Mn) of the thermoplastic polyimide is 1.0 to 2.0.

6. The thermoplastic polyimide according to claim 4, wherein permittivity of the thermoplastic polyimide is 2.0 or more.

7. A thermoplastic polyimide, comprising:
a repeating unit represented by the following Structural Formula I,
wherein an amount of an organic solvent detected in the thermoplastic polyimide by gas chromatography is 5 ppm by mass or less,

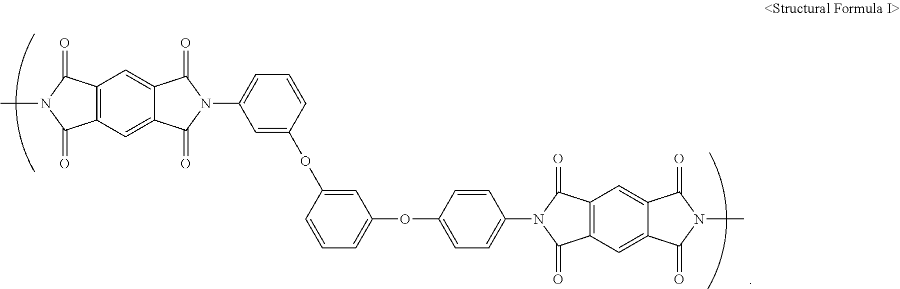

8. The thermoplastic polyimide according to claim 7, wherein a weight average molecular weight (Mw) of the thermoplastic polyimide measured by gel permeation chromatography is 10,000 to 1,000,000, and wherein a ratio (Mw/Mn) of the weight average molecular weight (Mw) to a number average molecular weight (Mn) of the thermoplastic polyimide is 1.0 to 2.0.

9. The thermoplastic polyimide according to claim 7, wherein permittivity of the thermoplastic polyimide is 2.0 or more.

10. A method for producing the thermoplastic polyimide according to claim 1, the method comprising:
reacting tetracarboxylic dianhydride with a diisocyanate compound, a diamine compound, or both thereof in a compressive fluid.

11. The method for producing the thermoplastic polyimide according to claim 10, wherein the reacting is performed at 180° C. or less.

12. The method for producing the thermoplastic polyimide according to claim 10, wherein the diamine compound is a meta-form aromatic diamine compound containing two or more ether bonds.

13. A method for producing the thermoplastic polyimide according to claim 4, the method comprising:
reacting tetracarboxylic dianhydride with a diisocyanate compound, a diamine compound, or both thereof in a compressive fluid.

14. A method for producing the thermoplastic polyimide according to claim 7, the method comprising:
reacting tetracarboxylic dianhydride with a diisocyanate compound, a diamine compound, or both thereof in a compressive fluid.

15. A thermoplastic polyimide foam body,
wherein the thermoplastic polyimide foam body is obtained by foaming the thermoplastic polyimide according to claim 1.

16. A method for producing the thermoplastic polyimide foam body according to claim 15, the method comprising:
reacting tetracarboxylic dianhydride with a diisocyanate compound, a diamine compound, or both thereof in a compressive fluid, to thereby obtain a thermoplastic polyimide, and
foaming the thermoplastic polyimide under reduced pressure.

17. A thermoplastic polyimide foam body,
wherein the thermoplastic polyimide foam body is obtained by foaming the thermoplastic polyimide according to claim 4.

18. A method for producing the thermoplastic polyimide foam body according to claim 17, the method comprising:
reacting tetracarboxylic dianhydride with a diisocyanate compound, a diamine compound, or both thereof in a compressive fluid, to thereby obtain a thermoplastic polyimide, and
foaming the thermoplastic polyimide under reduced pressure.

19. A thermoplastic polyimide foam body,
wherein the thermoplastic polyimide foam body is obtained by foaming the thermoplastic polyimide according to claim 7.

20. A method for producing the thermoplastic polyimide foam body according to claim 19, the method comprising:
reacting tetracarboxylic dianhydride with a diisocyanate compound, a diamine compound, or both thereof in a compressive fluid, to thereby obtain a thermoplastic polyimide, and
foaming the thermoplastic polyimide under reduced pressure.
